(19) United States
(12) Patent Application Publication
(10) Pub. No.: US 2019/0095660 A1
(43) Pub. Date: Mar. 28, 2019

(54) HOUSING

(71) Applicant: SHARP KABUSHIKI KAISHA, Sakai City, Osaka (JP)

(72) Inventors: MASAFUMI UENO, Sakai City (JP); MASAAKI MORIYA, Sakai City (JP); NAOKI SHIOBARA, Sakai City (JP); MITSURU HINENO, Sakai City (JP); TOMOHIRO OMATSU, Sakai City (JP); HIROYUKI FURUKAWA, Sakai City (JP); YASUHIRO SUGITA, Sakai City (JP); SHINJI YAMAGISHI, Sakai City (JP); JEAN MUGIRANEZA, Sakai City (JP)

(73) Assignee: SHARP KABUSHIKI KAISHA, Sakai City, Osaka (JP)

(21) Appl. No.: 16/304,285

(22) PCT Filed: Mar. 28, 2017
(86) PCT No.: PCT/JP2017/012523

§ 371 Date: Nov. 24, 2018

(30) Foreign Application Priority Data
Jun. 8, 2016 (JP) 2016-114842

(51) Int. Cl. G06K 7/10; H01Q 1/22; H01Q 1/44

(52) U.S. Cl. CPC G06K 7/10297; H01Q 1/44; H01Q 1/2208

(57) ABSTRACT

Near field radio communication with a communication device located at or near a housing is enabled in a simple configuration. A housing defining at least part of a space having a prescribed shape includes an NFC antenna. In addition, the NFC antenna is disposed along a surface of the housing for performing the near field radio communication with an NFC card located inside the space having the prescribed shape.

### TECHNICAL FIELD

The following disclosure relates to a housing in which a communication device is disposed.

### BACKGROUND ART

In recent years, various techniques related to near field radio communication (Near Field Communication, NFC) have been proposed. PTL 1 discloses, as an example, a technique for enabling increase in the number of communication directions in a proximity type non-contact communication device.

### CITATION LIST

### Patent Literature

PTL 1: JP 2014-110481 A (published on Jun. 12, 2014)

### SUMMARY OF INVENTION

### Technical Problem

An objective of an aspect of the present disclosure is to provide a housing capable of enabling near field radio communication with a communication device located in a vicinity of the housing in a simple configuration.

### Solution to Problem

In order to solve the above-described problem, a housing according to an aspect of the present disclosure is a housing defining at least part of a space having a prescribed shape, and includes an antenna disposed along a surface of the housing in order to perform near field radio communication with a communication device located inside the space defined by the housing.

### Advantageous Effects of Invention

The housing according to an aspect of the present disclosure enables near field radio communication with a communication device located in a vicinity of the housing in a simple configuration.

### BRIEF DESCRIPTION OF DRAWINGS

FIG. 1A is a diagram illustrating a configuration example of a housing according to a first embodiment, and FIG. 1B is a diagram illustrating a state in which a smartphone is held over an NFC antenna from the outside of the housing.

FIG. 2 is a functional block diagram illustrating a configuration of an information management system according to the first embodiment.

FIG. 3 is a diagram illustrating a flow example of information processing in the information management system according to the first embodiment.

FIG. 4 is a diagram illustrating a configuration example of a housing according to a modification of the first embodiment.

FIG. 5 is a diagram illustrating another configuration example of the housing according to the modification of the first embodiment.

FIG. 6 is a diagram illustrating a configuration example of a housing according to a second embodiment.

FIG. 7 is a diagram illustrating a configuration example of a housing according to a third embodiment.

FIG. 8 is a functional block diagram illustrating a configuration of a position management system according to the third embodiment.

### DESCRIPTION OF EMBODIMENTS

### First Embodiment

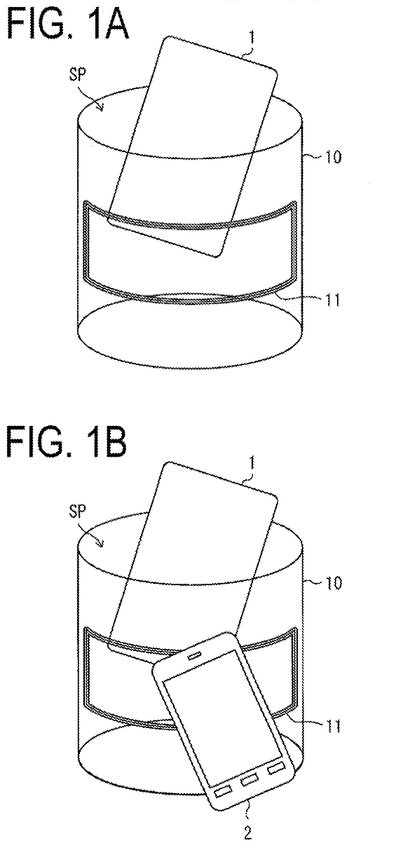

Hereinafter, a first embodiment of the present disclosure will be described based on FIGS. 1A, 1B to 4. As will be described below, a housing according to an aspect of the present disclosure serves to define at least part of a space having a prescribed shape, in order to enable near field radio communication with a communication device located in a vicinity (e.g., the inside) of the housing in a simple configuration.

Note that the NFC includes all types of short-range radio communication, and includes, for example, near field radio communication that uses Radio Frequency IDentification (RFID) technology such as a non-contact Integrated Circuit (IC) card or a non-contact IC tag, and the like. In the present embodiment, it may be understood that the term “communication” means the NFC, unless otherwise stated.

### Housing 10

FIG. 1A is a diagram illustrating an overview of a housing 10 according to the present embodiment. As illustrated in FIG. 1A, the housing 10 has a cylindrical shape (e.g., a cup shape) including a bottom surface. The housing 10 has (i) a side surface with a cylindrical shape, and includes (ii) a closed bottom surface (lower surface). Further, a top portion of the housing 10 is provided with an opening portion. Note that, in the present embodiment, an upper/lower direction is a vertical direction, for example.

By constituting the housing 10 as described above, a cylindrical space (inner space) SP is defined by the opening portion and the surfaces (the side surface and the bottom surface) of the housing 10. That is, the housing 10 is a member defining the cylindrical space SP as a space having a prescribed shape.

Note that, in the present embodiment, a case in which the whole prescribed space is defined by the housing 10 is illustrated as an example, but a housing according to an aspect of the present disclosure may define part of the prescribed space. This also applies to each modification and each embodiment described below.

Here, an example of a case in which a housing according to an aspect of the present disclosure defines part of a prescribed space is described. As an example, consider a case in which a single housing (a first housing) according to an aspect of the present disclosure, and another housing (a second housing) according to an aspect of the present disclosure are connected with each other. In this case, the first housing and the second housing define an entire prescribed space. Each of the first housing and the second housing defines part of the prescribed space.

Additionally, as illustrated in FIG. 1A, the housing 10 includes a cylindrical portion inside which a communication device (e.g., an NFC card 1) described later can enter. Providing the cylindrical portion makes it easy for the housing 10 to house a communication device inside thereof. Note that, a shape of the housing 10 is not limited to the cup-shape as long as the housing 10 has the cylindrical portion. For example, the shape of the housing 10 may be a vase shape that includes a bottom surface and a side surface.

In addition, in the present embodiment, descriptions will be given using a case in which the housing 10 is made of glass, for example, and the whole side surface of the housing 10 is optically transparent, as an example. However, the housing 10 may be constituted such that at least part of the housing 10 is optically transparent. Additionally, as will be described later, the housing 10 may not necessarily be optically transparent. That is, the housing 10 may be made of an opaque material.

A material that does not adversely affect radio communication by an NFC antenna 11 described later suffices as a material of the housing 10. That is, a material that has relatively low electromagnetic wave shielding performance suffices as the material of the housing 10. Accordingly, a non-metal material is preferably selected as the material of the housing 10.

The housing 10 includes the NFC antenna 11 (antenna) disposed along the side surface (in other words, along a substantially arc-like curve) of the housing 10. The NFC antenna 11, for example, is a loop antenna, and is disposed to perform the near field radio communication with the NFC card 1 (a communication device, a first communication device) located inside the space SP. Note that, the communication device may be referred to as a client device or an NFC terminal.

The NFC antenna 11 is preferably formed as a flexible member so as to be capable of being disposed (stuck) on curved surfaces having various shapes. The NFC antenna 11 has a function serving as a tag reader for detecting the NFC card 1 as a communication terminal (also referred to as an NFC tag), and transmitting and receiving information.

As an example, the NFC antenna 11 is formed inside a transparent NFC antenna sheet (not illustrated). The NFC antenna sheet serves as a protection member for protecting (covering) the NFC antenna 11.

As a material of the NFC antenna sheet, for example, synthetic resin having high transmittance, such as methacrylic resin, polycarbonate resin, polyester resin (e.g., polyethylene terephthalate), vinyl chloride resin, cellulosic resin (e.g., triacetylcellulose), rubber type resin, polyurethane resin, or polyvinyl acetate resin, is usable. Additionally, as the material of the NFC antenna sheet, a copolymer such as vinyl chloride-vinyl acetate copolymer resin or ethylene-vinyl acetate copolymer resin may be used.

In the present embodiment, the NFC antenna 11 may be constituted by forming a mesh shape (grid shape, net shape) formed of a metal wire having a diameter of about 5 μm as a shape illustrated in FIG. 1A, FIG. 1B, and the like. Accordingly, the NFC antenna 11 is formed to have the mesh shape configured with very thin metal wire grids (metal mesh), and thus is optically transparent.

Thus, the NFC antenna 11 seems to be almost transparent when viewed from a distance. Note that, in FIG. 1A, FIG. 1B, and the like, for convenience of explanation, the NFC antenna 11 is denoted by a solid line, but the NFC antenna is almost transparent actually, and viewability of the housing 10 is not hindered.

An example of a manufacturing method of the NFC antenna sheet and the NFC antenna 11 is as follows. First, on a front side sheet material constituting one surface (front surface) of the NFC antenna sheet, for example, a copper film or a silver film is stuck as a metal material. Subsequently, a mask on which a mesh shaped pattern and a pattern of electrode wiring line are formed is transferred in a metal material manner. After that, etching processing is performed to leave the above patterns on the front side sheet material, and the NFC antenna 11 having the mesh shape is formed.

Then, a backside sheet material constituting a back surface (an opposite surface to the front surface) of the NFC antenna sheet is bonded to the NFC antenna front side sheet material to sandwich the NFC antenna sheet. Accordingly, the NFC antenna sheet is formed. Note that, the above metal material may be, in addition to the copper film or the silver film described above, a film of gold, platinum, tin, aluminum, iron, nickel, or alloy thereof.

Further, the NFC antenna 11 may be constituted of a transparent conductive material such as Indium Tin Oxide (ITO), for example. In this case, the NFC antenna 11 may not necessarily be formed to have the above-described mesh shape.

The NFC card 1 may be a card containing a built-in antenna (not illustrated) for NFC communication, for example. As an example, consider a case in which the NFC card 1 is a card for personal authentication (e.g., a patient registration card for a hospital). In this case, the housing 10 may be used as a container (e.g., a container for the patient registration card) in which the NFC card 1 is put. For example, in a case that a patient visiting a hospital puts the NFC card 1 inside the housing 10 (inside the space SP), the NFC card 1 is located in a vicinity of the NFC antenna 11, and thus communication between the NFC card 1 and the NFC antenna 11 is enabled.

Here, various types of specific information given to a communication device (the NFC card 1) in advance are collectively referred to as terminal information. The terminal information may include (i) a terminal ID as an identification number specific to the communication device, (ii) terminal type information indicating a type of the communication device, (iii) a personal ID as an identification number of an owner of the communication device, and the like.

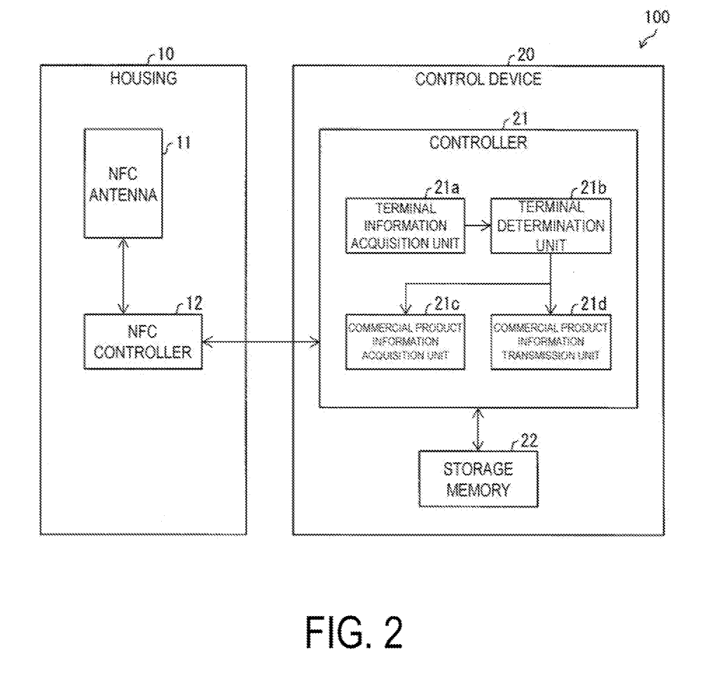

Performing communication between the NFC card 1 and the NFC antenna 11 makes it possible for a controller 21 of an information management system 100 described later (see FIG. 2) to acquire the personal ID included in the terminal information of the NFC card 1 via the NFC antenna 11. That is, the controller 21 can perform personal authentication for the owner (patient) of the NFC card 1.

Note that, the housing 10 may be constituted such that a bottom surface thereof operates according to an authentication result (e.g., a result of the above personal authentication) by the controller 21. For example, an opening/closing mechanism for opening/closing the bottom surface of the housing 10 according to the authentication result may be provided. In this case, according to the authentication result, it is possible to open the bottom surface of the housing 10 and discharge the NFC card 1, which had been put inside the housing 10, to the outside the housing 10.

Additionally, in the case of opening the bottom surface of the housing 10 with the opening/closing mechanism, according to the authentication result, in a state that the bottom surface is open, an inclination angle (an angle of the bottom surface with respect to a horizontal plane) or an inclination direction of the bottom surface may vary. Thus, according to the authentication result, it is also possible to discharge the NFC card 1, which had been put inside the housing 10, to a different position or in a different direction outside the housing 10. As an example, in a case of performing gender authentication of a patient based on a personal ID, according to gender information (information indicating that the receiver is a male or a female) acquired as a result of the authentication, the NFC card 1 may be discharged to different directions outside the housing 10.

As described above, FIG. 1A illustrates a case in which the NFC card 1 as a communication device is made to approach the NFC antenna 11 and communicates with the NFC antenna 11 inside the housing 10 (inside the space SP). However, as illustrated in FIG. 1B and described later, communication between the communication device and the NFC antenna 11 is possible outside the housing 10 (outside the space SP) as well.

FIG. 1B is a diagram illustrating a state in which a smartphone 2 (a communication device, a second communication device) is held over (made to approach) the NFC antenna 11 from the outside of the housing 10. The smartphone 2 is a communication terminal containing a built-in antenna (not illustrated) for the NFC communication, for example. That is, the smartphone 2 is a communication device different from the NFC card 1.

As illustrated in FIG. 1B, in a case that a user holds the smartphone 2 over the NFC antenna 11 from the outside of the housing 10, the smartphone 2 is disposed in the vicinity of the NFC antenna 11. Accordingly, communication between the smartphone 2 and the NFC antenna 11 is enabled.

Additionally, consider the case in which a user holds the smartphone 2 over the NFC antenna 11 from the outside of the housing 10, in a state that the NFC card 1 is housed inside the housing 10. In this case, the smartphone 2 is outside the space SP, and is disposed on a position facing the NFC card 1 across the NFC antenna 11.

Accordingly, the NFC antenna 11 located between the smartphone 2 and the NFC card 1 makes it possible to suitably assist communication between the smartphone 2 and the NFC card 1. Accordingly, it is possible to perform the communication between the smartphone 2 and the NFC card 1 more reliably.

More specifically, in the present embodiment, the NFC antenna 11 assists the communication between the NFC card 1 disposed inside the cylindrical space SP and the smartphone 2 disposed outside the space SP.

Note that, also in a case that the NFC card 1 is disposed outside the space SP and the smartphone 2 is disposed inside the space SP, the communication between the smartphone 2 and the NFC card 1 is possible via the NFC antenna 11.

### Information Management System 100

FIG. 2 is a functional block diagram illustrating a configuration of an information management system 100 according to the present embodiment. The information management system 100 includes the above housing 10 and a control device 20. Each member of the housing 10 and the control device 20 will be described below.

The housing 10 includes the above NFC antenna 11 and an NFC controller 12. The NFC controller 12 controls driving of the NFC antenna 11 based on a control signal from the controller 21 of the control device 20. Specifically, the NFC controller 12 periodically changes a magnitude of a radio signal (i.e. a magnetic field) emitted from the NFC antenna 11, and checks whether a client device exists in the vicinity of the NFC antenna 11 or not. This operation is referred to as polling.

Note that, in a case that the NFC card 1 (not illustrated in FIG. 2) is located in the vicinity of the NFC antenna 11, the above magnetic field changes due to the polling, and thus an inductive current is generated in an antenna built in the NFC card 1 for the NFC communication. This inductive current starts an IC chip (not illustrated) built in the NFC card 1. As a result, the NFC controller 12 is capable of transmitting/receiving various types of information wirelessly, between the NFC antenna 11 and the NFC card 1 (the IC chip, more specifically). Thus, the NFC controller 12 transmits the information wirelessly received (acquired) from the NFC card 1 (e.g., terminal information) to a radio communication unit (not illustrated) of the controller 21. As described above, the controller 21 can give an instruction (also may be referred to as an information acquisition instruction) to the NFC controller 12, and acquire various types of information from the NFC card 1 by the radio communication unit.

As an example, the NFC controller 12 is a chip of an NFC reader/writer (also referred to as a controller substrate). However, it is sufficient that the NFC controller 12 at least includes a function for reading various types of information from the NFC card 1, and a function of writing into the NFC card 1 is not mandatory.

The NFC controller 12 may be disposed on the bottom surface of the housing 10, for example. Additionally, part of the side surface of the housing 10 may be made of an opaque member, and the NFC controller 12 may be disposed on the opaque part. Further, the NFC controller 12 may be provided outside the housing 10. In this case, the NFC controller 12 is connected with the NFC antenna 11 via a cable. As described above, it is sufficient that the NFC controller 12 is a member capable of communicating with the NFC antenna 11 provided on the housing 10.

The control device 20 includes the controller 21 and a storage memory 22. The storage memory 22 stores various control programs and the like performed by the controller 21, for example, and is constituted of a non-volatility storage device such as a hard disk and a flash memory, for example.

A case in which the housing 10 is used as a container for housing a commercial product (not illustrated) will be described below as an example. Here, the NFC card 1 is an NFC tag attached to a commercial product (an NFC tag for managing commercial products: hereinafter, also referred to as a commercial product tag). Hereinafter, the terminal information of the NFC card 1 includes commercial product information indicating various types of information of a commercial product (e.g., a type or a price).

For example, in a case that an employee of a store houses a commercial product inside the housing 10, the NFC card 1 is located in the vicinity of the NFC antenna 11, and thus the communication between the NFC card 1 and the NFC antenna 11 is enabled. Accordingly, it is possible for the controller 21 to acquire the commercial product information included in the terminal information of the NFC card 1 via the NFC antenna 11.

Thus, the controller 21 (more specifically a commercial product information acquisition unit 21c described later) can specify a type of the commercial product housed (stored) inside the housing 10 if only the employee of the store houses the commercial product inside the housing 10. That is, according to the housing 10, it is possible to improve efficiency of commercial product management in a store.

Additionally, in a case that a communication terminal (e.g., the smartphone 2) is held over the NFC antenna 11 from the outside of the housing 10, communication between the communication terminal and the NFC card 1 via the NFC antenna 11 is enabled.

Accordingly, for example, in a case that a customer considering purchase of a commercial product stored inside the housing 10 holds his/her own smartphone 2 over the NFC antenna 11, the customer can acquire commercial product information included in terminal information of the NFC card 1, with the smartphone 2. As described above, according to the housing 10, it is possible to let a customer easily confirm commercial product information.

A specific configuration of the controller 21 will be described below. The controller 21 includes a terminal information acquisition unit 21a, a terminal determination unit 21b, the commercial product information acquisition unit 21c, and a commercial product information transmission unit 21d. The terminal information acquisition unit 21a acquires terminal information of a communication device (e.g., the NFC card 1) via the NFC controller 12. The terminal determination unit 21b determines a type of the communication device based on terminal type information included in the terminal information.

In a case that the terminal determination unit 21b determines that the communication device is a commercial product tag, the commercial product information acquisition unit 21c acquires commercial product information included in the terminal information. Additionally, the commercial product information transmission unit 21d transmits the commercial product information to an external device (e.g., the smartphone 2) of the control device 20.

Note that, an informing unit (e.g., an LED, a speaker, a display device) for indicating whether communication between the NFC antenna 11 and the communication device has been successful may further be provided in the information management system 100. In this case, the controller 21 may control operation of the informing unit based on a communication result between the NFC antenna 11 and the communication device. For example, a lighting pattern of an LED, or a type of a voice outputted from a speaker may be changed according to the communication result. In addition, the informing unit may be used for indicating the above-described authentication result in the controller 21.

### Flow of Information Processing in Information Management System 100

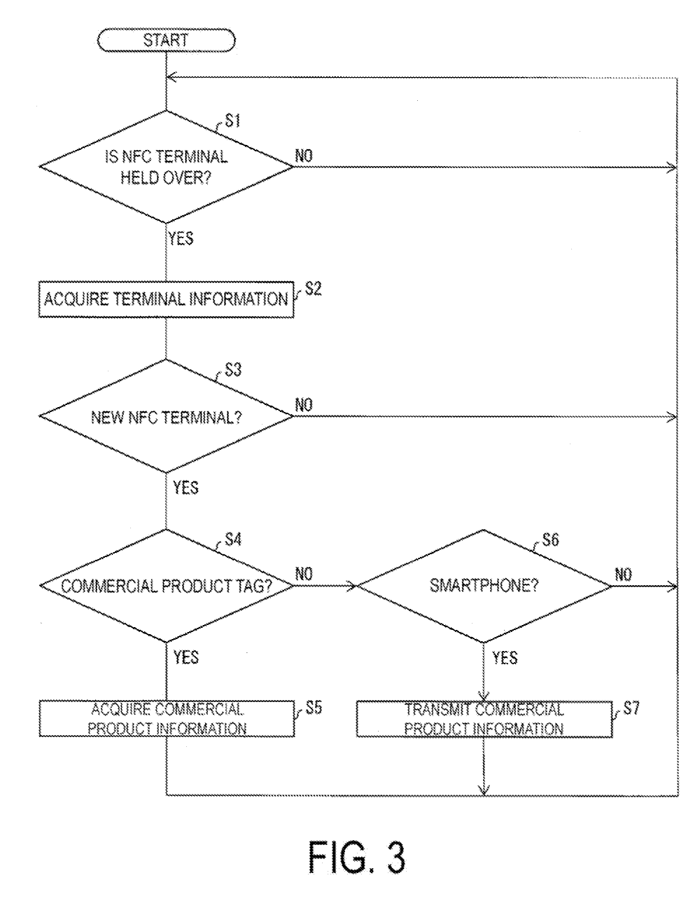

FIG. 3 is a flowchart showing a flow of information processes S1 to S7 in the information management system 100. First, the NFC controller 12 determines whether a communication device (an NFC terminal) is held over the NFC antenna 11 or not, by making the NFC antenna 11 perform polling (S1).

Then, in a case that the communication device is held over the NFC antenna 11 (YES in S1), the terminal information acquisition unit 21a acquires terminal information of the communication device via the NFC controller 12 (S2).

Next, the terminal determination unit 21b determines whether the communication device held over the NFC antenna 11 is a new communication device or not based on a terminal ID included in the terminal information (S3). Note that, a new communication device means that the communication device held over the NFC antenna 11 is not a communication device that has already communicated with the NFC antenna 11.

Note that the terminal ID of the communication terminal is stored in the storage memory 22 by the terminal information acquisition unit 21a at a time the terminal information acquisition unit 21a acquires the terminal ID. Thus, a new communication device has a terminal ID different from terminal IDs already stored in the storage memory 22. Accordingly, the terminal determination unit 21b can determine whether the communication device held over the NFC antenna 11 is a new communication device or not by checking (comparing) its ID and the terminal IDs stored in the storage memory 22.

Note that, assume that the NFC card 1 has already communicated with the NFC antenna 11 at a time a commercial product is housed inside the housing 10 before the process S1 starts. In this case, as an example, a new communication device is a communication device that is different from the NFC card 1.

In a case that the communication device held over the NFC antenna 11 is not a new communication device (NO in S3), the controller 21 gives an instruction to the NFC controller 12 to stop communication between the NFC antenna 11 and the client device.

On the other hand, in a case that the communication device held over the NFC antenna 11 is a new communication device (YES in S3), the terminal determination unit 21b determines a type of the communication device based on terminal type information included in the terminal information.

First, the terminal determination unit 21b determines whether the communication device is a commercial product tag or not (S4). In a case that the communication device is a commercial product tag (YES in S4), the commercial product information acquisition unit 21c acquires commercial product information included in the terminal information (a process S5) and stores the commercial product information in the storage memory 22. Subsequently, the processing returns to the process S1.

On the other hand, in a case that the communication device is not a commercial product tag (NO in S4), the terminal determination unit 21b determines whether the communication device held over the NFC antenna 11 is a smartphone or not (S6). In a case that the communication device is a smartphone (YES in S6), the commercial product information transmission unit 21d transmits the commercial product information stored in the storage memory 22 to the smartphone (S7). Subsequently, the processing returns to the process S1.

Note that, a data format of the commercial product information that the commercial product information transmission unit 21d transmits to the smartphone is not specifically limited. As an example, a data format of the commercial product information may be (i) a Uniform Resource Locator (URL) indicating an address of a website indicating the commercial product information, (ii) a link to a directory on a server storing the commercial product information, or (iii) text data describing the commercial product information.

Additionally, in a case that a data amount of the commercial product information is large, the commercial product information transmission unit 21d may use a radio communication method (more appropriate method for large amount data communication) different from the NFC, and transmit data to the smartphone.

### Effect of Housing 10

As described above, the NFC antenna 11 is disposed along the side surface of the housing 10 for performing the near field radio communication with a communication device (e.g., the NFC card 1, the smartphone 2) located inside the space SP defined by the housing 10.

Since the NFC antenna 11 is disposed along the side surface of the housing 10 (along a substantially arc-like curve), the NFC between the communication device and the NFC antenna 11 is possible without making the communication device face the NFC antenna 11, inside the space SP defined by the housing 10. That is, stable communication (the NFC) is possible, irrelevant of orientation of the communication device, by making the communication device approach the NFC antenna 11 inside the space SP.

As described above, according to the disposition of the NFC antenna 11, communication with a communication device located inside the space SP defined by the housing 10 is enabled without significantly changing the shape of the housing 10. Thus, according to the housing 10, it is possible to enable the near field radio communication with a communication device located in the vicinity (e.g., inside) of the housing 10 in a simple configuration. Additionally, also in a case of making the communication device approach the NFC antenna 11 outside the space SP, stable communication (the NFC) is possible. As described above, it is possible to increase a degree of freedom of communication directions.

Further, according to the above disposition of the NFC antenna 11, the NFC antenna 11 can assist communication between respective communication devices disposed in and out of the housing 10 (a first communication device disposed inside the housing 10 and a second communication device disposed outside the housing 10). Thus, it is possible to perform the NFC between the respective communication devices disposed in and out of the housing 10 more reliably.

As an example, in a case that a commercial product housed inside the housing 10 is precious, opportunities in which a user (an employee of a store or a customer) directly touches the commercial product are preferably reduced in order to prevent quality deterioration of the commercial product.

Thus, according to the housing 10, since it is possible to communicate with the first communication device (e.g., the NFC card 1 as a commercial product tag) by using the second communication device (e.g., the smartphone 2), the user can acquire commercial product information without directly touching the commercial product. As a result, it is possible to prevent the quality deterioration of the commercial product.

In addition, also in a case that a commercial product housed inside the housing 10 is frequently replaced, the configuration of the housing 10 is beneficial. The reason is that the second communication device can acquire the commercial product information and let a user easily confirm what type of a commercial product is currently housed inside the housing 10.

In addition, as described above, in the housing 10, at least part of the housing 10 is transparent. Accordingly, a user can visually recognize a communication device located inside the space SP, and thus it is possible to enhance convenience at a time the user performs the NFC.

Further, in the present embodiment, the NFC antenna 11 is a transparent antenna disposed on a transparent portion of the housing 10. This makes it possible to prevent the viewability of the communication device disposed inside the space SP from being hindered due to the NFC antenna 11.

Note that, in a case that a plurality of the NFC antennas are provided (e.g., a first modification described later), not all the NFC antennas may not be the transparent antennas. The reason is that it is possible to enhance viewability for a user as long as at least one transparent antenna is disposed on the transparent portion of the housing 10.

However, as will be described in a second modification described later, in a case that necessity for enhancing the viewability for a user is low, the housing 10 and the NFC antenna 11 may not necessarily be transparent.

Note that, in the present embodiment, the housing 10 with the opening portion provided on the top portion is described, but a direction in which the opening portion is disposed is not limited thereto. For example, the housing 10 may be used in a state of being inclined by 45 degrees or 90 degrees with respect to the vertical direction. This also applies to each modification and each embodiment described below.

### First Modification

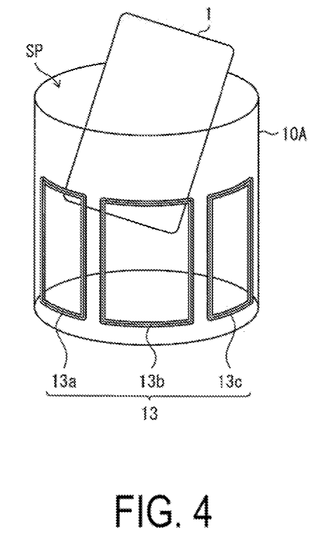

FIG. 4 is a diagram illustrating a configuration example of a housing 10A as a first modification according to the above first embodiment. The housing 10A is obtained by replacing the NFC antenna 11 with a plurality of NFC antennas 13a to 13c (antennas) in the above housing 10. Note that, these NFC antennas 13a to 13c are also collectively referred to as an NFC antenna 13 (antenna). That is, the housing 10A differs from the housing 10 in that the plurality of the NFC antennas 13 (the NFC antennas 13a to 13c) are provided along a side surface.

Similarly to the above NFC antenna 11, the plurality of the NFC antennas 13 are provided along the side surface of the housing 10A having a cylindrical shape. Accordingly, the communication between the NFC card 1 and the NFC antenna 11 is possible, irrelevant of orientation of the NFC card 1 inside the above space SP.

In the above housing 10, a single NFC antenna 11 is provided. Thus, for example, in a case that a size of the housing 10 is large, it is concerned that a region may be generated in which communication between the communication device and the NFC antenna 11 is difficult or cannot be made inside the above space SP.

On the other hand, in the housing 10A, providing the plurality of the NFC antennas 13 reduces the possibility that the region may be generated in which the communication is difficult or cannot be made inside the space SP. Which of the housings 10 and 10A is adopted may be appropriately determined by a housing manufacturer, depending on respective sizes and shapes of the housings, and communication performance of the NFC antenna.

Note that, the housing 10A illustrated in FIG. 4 includes three of the NFC antennas 13, but the number of the plurality of the NFC antennas 13 may be two, or may be four or more. The number of the NFC antennas 13 may be appropriately determined by a manufacturer of the housing 10A. Additionally, all the plurality of the NFC antennas 13 may be activated(operated) simultaneously, or may be activated in order one by one.

Further, by specifying an NFC antenna that has communicated with the NFC card 1 among the plurality of the NFC antennas 13, it is possible to specify an approximate position of the NFC card 1 inside the housing 10A. A process for specifying the approximate position of the NFC card 1 will be described in a third embodiment described later.

Note that, similarly to the above housing 10, by holding the smartphone 2 over the NFC antenna 13 from the outside of the housing 10A, communication between the smartphone 2 and the NFC antenna 13 is enabled. Further, communication between the smartphone 2 and the NFC card 1 is possible via the NFC antenna 13. In this case, for example, the NFC card 1 may communicate with the NFC antenna 13a and the smartphone 2 may communicate with the NFC antenna 13c. In a case of viewing the NFC antenna 13 as a whole, it is possible to describe that the smartphone 2 is outside the space SP, and is disposed on a position facing the NFC card 1 across the NFC antenna 13.

### Second Modification

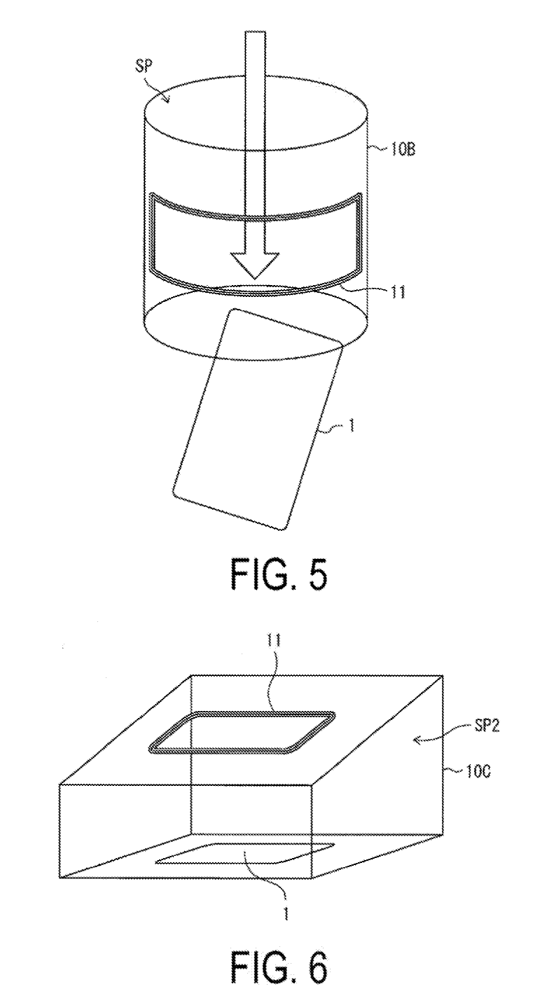

FIG. 5 is a diagram illustrating a configuration example of a housing 10B as a second modification according to the above first embodiment. The housing 10B is obtained by removing the bottom surface from the above housing 10. That is, the housing 10B differs from the housing 10 in that the housing 10B is formed to have a pipe shape without a bottom surface (an opening portion is provided in a lower portion as well).

Since the housing 10B does not include a bottom surface, the NFC card 1 put inside the space SP from above the housing 10B drops downward (in a direction denoted by a white arrow in FIG. 5) without staying inside the space SP. That is, the housing 10B has a cylindrical portion so that the NFC card 1 easily passes through (drops) inside the housing 10B.

As an example, as described above, consider a case in which the NFC card 1 is a commercial product tag. In this case, the housing 10B may be used for checkout of a commercial product. That is, the housing 10B may be used as part of an automated cashier. In this case, a customer puts each commercial product he/she is going to buy inside the space SP from above the housing 10B. That is, the customer allows each commercial product to pass through in order inside the housing 10B.

Then, at a time the commercial product in the middle of passing through inside the housing 10B reaches the vicinity of the NFC antenna 11, communication between the NFC card 1 and the NFC antenna 11 is performed. Accordingly, it is possible for the commercial product information acquisition unit 21c to acquire commercial product information from the NFC card 1.

Then, each time the commercial product information acquisition unit 21c acquires a commercial product price from the NFC card 1 (commercial product tag) corresponding to each commercial product, the commercial product information acquisition unit 21c adds up commercial product prices. Accordingly, it is possible to calculate a total price of the respective commercial products the customer is going to buy. Thus, the controller 21 is capable of displaying the above total price on a display device (not illustrated) communicatively connected with the housing 10B, for example, and notifying the customer of an amount to pay.

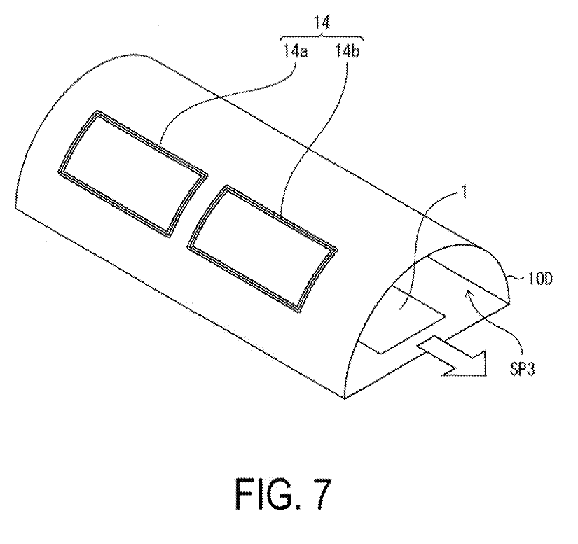

Note that, in the configuration in FIG. 5, it can be said that necessity for enhancing viewability of the user (e.g., customer) is relatively low. The reason is that a user may not need to visually recognize a commercial product in the middle of passing through inside the housing 10B (a commercial product in the middle of checkout). Thus, the housing 10B and the NFC antenna 11 may not necessarily be transparent. This also applies to the third embodiment described below (see FIG. 7 described later).

### Second Embodiment

A second embodiment of the present disclosure will be described based on FIG. 6, as follows. Note that, for convenience of explanation, components illustrated in respective embodiments are designated by the same reference numerals as those having the same function, and the descriptions of these components will be omitted.

In the first embodiment and each modification described above, each of the housings 10 to 10B with the cylindrical shape was described. However, a shape of a housing according to an aspect of the present disclosure may not necessarily be limited to the cylindrical shape only. In the present embodiment and the third embodiment described later, varieties of shapes of the housing will be described.

FIG. 6 is a diagram illustrating a configuration example of a housing 10C according to the present embodiment. As illustrated in FIG. 6, the housing 10C has a box shape and all surfaces are planar. That is, the housing 10C does not include a cylindrical portion or part of a cylindrical portion.

In the present embodiment, a case in which the housing 10C is formed as a showcase is illustrated. By constituting the housing 10C as described above, a space SP2 having a prescribed shape is defined by a top surface (upper surface), a side surface, and a bottom surface (lower surface) of the housing 10C. That is, the housing 10C is a member defining the space SP2 having no curved surface.

The housing 10C is preferably transparent so that a body disposed inside (a commercial product with the NFC card 1 as a commercial product tag attached) is visually recognizable from an outside. Further, the NFC antenna 11 is preferably transparent as well, so as not to reduce transparency of the housing 10C.

As illustrated in FIG. 6, the top surface of the housing 10C inclines with respect to a vertical direction, and the NFC antenna 11 is disposed along the top surface. However, in addition to the NFC antenna 11 (or in place of the NFC antenna 11), an NFC antenna different from the NFC antenna 11 may be provided at least on the side surface or the bottom surface of the housing 10C.

Specifically, it is sufficient that the NFC antenna 11 is provided to be able to assist communication between a first communication device (e.g., the NFC card 1) disposed inside the space SP2 and a second communication device (e.g., the smartphone 2, not illustrated in FIG. 6) being outside the space SP2 and disposed on a position facing the first communication device across the NFC antenna 11. That is, in the housing 10C, a position on which the NFC antenna 11 is provided is not specifically limited, and the position may be appropriately determined by a manufacturer of the housing 10C depending on a size or a shape of the housing 10C.

Also in the housing 10C, as in the cases of the first embodiment and each of the modifications described above, since the NFC antenna 11 is disposed along a surface of the housing 10C, it is possible to enable the near field radio communication with a communication device located inside the housing 10C in a simple configuration. Additionally, it is possible that communication between respective communication devices disposed in and out of the housing 10C is suitably performed.

Note that, in the present embodiment, as a housing that defines the space SP2 having no curved surface, the housing 10C with the box shape (showcase shape) was illustrated, but the shape of the housing is not limited thereto. As an example, the housing may be formed to have a plate shape. In this case, the housing is usable as a cover for covering an opening portion of a structure having a prescribed shape. In this case, the housing (cover) covers the opening portion to define a prescribed space (a space inside the opening portion of the structure).

### Third Embodiment

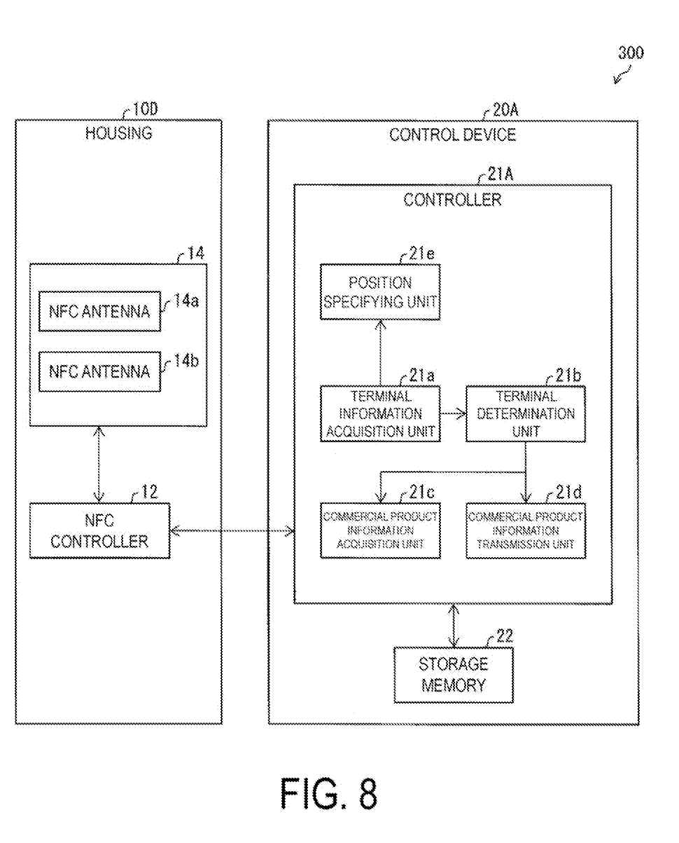

A third embodiment of the present disclosure will be described based on FIG. 7 and FIG. 8, as follows. FIG. 7 is a diagram illustrating a configuration example of a housing 10D according to the present embodiment. As illustrated in FIG. 7, the housing 10D has a semi-cylindrical shape (dome shape). That is, the housing 10D includes part of a cylindrical portion. The housing 10D is constituted, similarly to the housing 10B described above, such that the NFC card 1 (a client device) easily passes through inside the housing 10D.

In the present embodiment, the housing 10D is provided as a cover for covering a top portion of a conveyor belt (not illustrated) for transporting a commercial product (manufactured product) with the NFC card 1 attached, in a prescribed direction. By constituting the housing 10D as described above, a space SP3 having a prescribed shape is defined by the housing 10D and the conveyor belt. That is, the housing 10D is a member defining the semi-cylindrical space SP3.

As illustrated in FIG. 7, two NFC antennas 14a and 14b (antennas) are disposed along a surface (a side surface having the semi-cylindrical shape) of the housing 10D. Note that, these NFC antennas 14a and 14b are also collectively referred to as an NFC antenna 14 (antenna).

It is sufficient that the NFC antenna 14 is provided to be able to assist communication between a first communication device (e.g., the NFC card 1) disposed inside the space SP3 and a second communication device (e.g., the smartphone 2, not illustrated in FIG. 7) being outside the space SP3 and disposed on a position facing the first communication device across the NFC antenna 14. Thus, a position on which the NFC antenna 14 is provided is not specifically limited.

Note that, in the present embodiment, a description will be given by illustrating a case in which a traveling direction of the conveyor belt (a direction in which the commercial product is transported: a direction denoted by a white arrow in FIG. 7) is a direction from the NFC antenna 14a to the NFC antenna 14b).

Next, a position management system 300 according to the present embodiment will be described with reference to FIG. 8. FIG. 8 is a functional block diagram illustrating a configuration of the position management system 300 according to the present embodiment. The position management system 300 is obtained by adding a function of specifying an approximate position of the NFC card 1 to the above-described information management system 100.

As illustrated in FIG. 8, the position management system 300 includes the above housing 10D and a control device 20A. The control device 20A is obtained by replacing the controller 21 with a controller 21A in the above control device 20. Note that, the controller 21A is obtained by adding a position specifying unit 21e to the controller 21.

In the present embodiment, the terminal information acquisition unit 21a, in a case of acquiring terminal information of the NFC card 1, further acquires an antenna ID of the NFC antenna 14 that has communicated with the NFC card 1, and gives the antenna ID to the position specifying unit 21e.

Note that, the antenna ID is an identification number specific to each of a plurality of the NFC antennas 14. Thus, each of the NFC antennas 14a and 14b is assigned a different antenna ID. This applies to the above NFC antenna 13 (NFC antennas 13a to 13c) in the same manner.

Position information associated with each antenna ID is configured in the position specifying unit 21e in advance. This position information may be coordinates indicating a position on the housing 10D on which each of the plurality of the NFC antennas 14 (NFC antennas 14a and 14b) is disposed. For example, in a case that a white arrow in the above FIG. 7 is an X axis, the position information may be an X coordinate indicating a position of each of the NFC antennas 14a and 14b.

The position specifying unit 21e specifies position information corresponding to the antenna ID given by the terminal information acquisition unit 21a. This position information may be used as information indicating an approximate position on which the NFC card 1 is disposed.

For example, in a case that a commercial product on the conveyor belt is transported to a vicinity of the NFC antenna 14a, the NFC card 1 is located in the vicinity of the NFC antenna 14a. Accordingly, communication between the NFC card 1 and the NFC antenna 14a is performed, and an antenna ID of the NFC antenna 14a is given to the position specifying unit 21e. As a result, the position specifying unit 21e specifies position information associated with the NFC antenna 14a. That is, the position information indicates that the NFC card 1 is located in the vicinity of the NFC antenna 14a.

Next, in a case that a commercial product is transported to a vicinity of the NFC antenna 14b, the NFC card 1 is located in the vicinity of the NFC antenna 14b. Accordingly, communication between the NFC card 1 and the NFC antenna 14b is performed, and an antenna ID of the NFC antenna 14b is given to the position specifying unit 21e. As a result, the position specifying unit 21e specifies position information associated with the NFC antenna 14b. That is, the position information indicates that the NFC card 1 is located in the vicinity of the NFC antenna 14b.

As described above, according to the position management system 300, it is possible to specify an approximate position on which the NFC card 1 has communicated with the NFC antenna 14 based on the above antenna ID. In other words, it is possible to specify an approximate position of the commercial product on the conveyor belt. Additionally, as described above, it is possible for the commercial product information acquisition unit 21c to acquire commercial product information included in the terminal information of the NFC card 1 from the NFC antenna 14.

Thus, the position management system 300 can specify which commercial product exists on which position on the conveyor belt, based on a communication result between the NFC card 1 and the NFC antenna 14. As described above, according to the position management system 300, for example, it is possible to improve efficiency of commercial product management (production management of each commercial product) at a factory.

Note that, the housing 10B in the above FIG. 5 may be disposed in a horizontal direction, and the conveyor belt described in the present embodiment may be provided inside the space SP. In this case, a plurality of the NFC antennas (e.g., the NFC antennas 13 in the above FIG. 4) are preferably provided on a surface of the housing 10B.

### Implementation Example by Software

Control blocks (in particular, the controllers 21 and 21A) of the information management system 100 and the position management system 300 may be implemented by a logic circuit (hardware) formed in an Integrated Circuit (IC chip) and the like, or may be implemented by software using a Central Processing Unit (CPU).

In the case of using the latter, each of the information management system 100 and the position management system 300 includes a CPU for executing instructions of a program which is software for enabling each function, a Read Only Memory (ROM) or a storage device (each of these is referred to as a “recording medium”) in which the program and various types of data are recorded in a computer-readable (or CPU-readable) manner, a Random Access Memory (RAM) in which the program is loaded, and the like. Then, the computer (or CPU) reads the program from the recording medium and executes the program to achieve the object of the present disclosure. As the recording medium, a “non-transitory tangible medium”, such as a tape, a disk, a card, a semiconductor memory, and a programmable logic circuit may be used. Further, the program may be supplied to the computer via any transmission medium (a communication network, a broadcast wave, or the like) able to transmit the program. Note that the present disclosure may be implemented in a form of data signal embedded in a carrier wave, which is embodied by electronic transmission of the program.

### SUMMARY

A housing according to a first aspect of the present disclosure is a housing defining at least part of a space having a prescribed shape, and includes an antenna disposed along a surface of the housing in order to perform near field radio communication with a communication device located inside the space defined by the housing.

According to the above configuration, since the antenna is disposed along the surface of the housing, it is possible to enable the near field radio communication (NFC) with the communication device located inside the space defined by the housing without significantly changing the shape of the housing. Accordingly, it is possible to enable the near field radio communication with a communication device located at or near the housing in a simple configuration.

In a housing according to a second aspect of the present disclosure, in the first aspect, at least part of the housing is preferably transparent.

According to the above configuration, a user can visually recognize a communication device located inside the space.

In a housing according to a third aspect of the present disclosure, in the above second aspect, the antenna preferably includes a transparent antenna disposed on a transparent portion of the housing.

According to the above configuration, since the antenna includes the transparent antenna, it is possible to prevent viewability of a communication device disposed inside the space from being hindered due to the antenna.

In a housing according to a fourth aspect of the present disclosure, in one of the first to the third aspects, the housing preferably includes a cylindrical portion or part of a cylindrical portion, inside which the communication device is capable of entering.

According to the configuration, it is possible to achieve a housing inside which a communication device easily passes through or a communication device is easily housed.

In a housing according to a fifth aspect of the present disclosure, in the fourth aspect, the antenna preferably assists communication between a first communication device disposed inside the cylindrical portion or part of the cylindrical portion and a second communication device disposed outside the cylindrical portion or part of the cylindrical portion.

According to the above configuration, in a case that the housing includes the cylindrical portion or part of the cylindrical portion (e.g., the case of the above FIG. 1A, FIG. 1B and the like), it is possible to perform the communication between respective communication devices disposed in and out of the housing (the first communication device disposed inside the housing and the second communication device disposed outside the housing) more reliably.

In a housing according to a sixth aspect of the present disclosure, in one of the first to the fourth aspects, the antenna preferably assists communication between a first communication device disposed inside a space having a prescribed shape and a second communication device being outside the space and disposed at a position facing the first communication device across the antenna.

According to the above configuration, also in a case that the housing does not include the cylindrical portion or part of the cylindrical portion (e.g., the case of the above FIG. 6, and the like), it is possible to perform the communication between the respective communication devices disposed in and out of the housing more reliably. Additionally, also in a case that the housing includes the cylindrical portion or part of the cylindrical portion, it is possible to perform the communication between the respective communication devices disposed in and out of the housing further reliably.

### ADDITIONAL NOTES

The present disclosure is not limited to each of the above-described embodiments. It is possible to make various modifications within the scope of the claims. An embodiment obtained by appropriately combining technical elements each disclosed in different embodiments falls also within the technical scope of the present disclosure. Furthermore, technical elements disclosed in the respective embodiments may be combined to provide a new technical feature.

### CROSS REFERENCE OF RELATED DISCLOSURE

The present application claims the benefit of priority to Japanese Patent Application: Japanese Patent Application No. 2016-114842 filed on Jun. 8, 2016, and by reference thereto, all of its contents is included in this document.

### REFERENCE SIGNS LIST

1. NFC card (communication device, first communication device)
2. Smartphone (communication device, second communication device)
10, 10A, 10B, 10C, 10D Housing
11, 13, 14, 13a to 13c, 14a to 14b NFC antenna (antenna)
100 Information management system
300 Position management system
SP, SP2, SP3 Space

1. A housing defining at least part of a space having a prescribed shape, the housing comprising:
an antenna disposed along a surface of the housing and configured to perform near field radio communication with a communication device located inside the space defined by the housing.

2. The housing according to claim 1,
wherein at least part of the housing is transparent.

3. The housing according to claim 2,
wherein the antenna includes a transparent antenna disposed on a transparent portion of the housing.

4. The housing according to claim 1,
wherein the housing includes a cylindrical portion or part of a cylindrical portion, inside which the communication device is allowed to enter.

5. The housing according to claim 4,
wherein the antenna is configured to assist communication between a first communication device disposed inside the cylindrical portion or the part of the cylindrical portion and a second communication device disposed outside the cylindrical portion or the part of the cylindrical portion.

6. The housing according to claim 1,
wherein the antenna is configured to assist communication between a first communication device disposed inside the space having a prescribed shape and a second communication device being outside the space and disposed on a position facing the first communication device across the antenna.

7. The housing according to claim 2,
wherein the housing includes a cylindrical portion or part of a cylindrical portion, inside which the communication device is allowed to enter.

8. The housing according to claim 3,
wherein the housing includes a cylindrical portion or part of a cylindrical portion, inside which the communication device is allowed to enter.

9. The housing according to claim 7,
wherein the antenna is configured to assist communication between a first communication device disposed inside the cylindrical portion or the part of the cylindrical portion and a second communication device disposed outside the cylindrical portion or the part of the cylindrical portion.

10. The housing according to claim 8,
wherein the antenna is configured to assist communication between a first communication device disposed inside the cylindrical portion or the part of the cylindrical portion and a second communication device disposed outside the cylindrical portion or the part of the cylindrical portion.

11. The housing according to claim 2,
wherein the antenna is configured to assist communication between a first communication device disposed inside the space having a prescribed shape and a second communication device being outside the space and disposed on a position facing the first communication device across the antenna.

12. The housing according to claim 3,
wherein the antenna is configured to assist communication between a first communication device disposed inside the space having a prescribed shape and a second communication device being outside the space and disposed on a position facing the first communication device across the antenna.

13. The housing according to claim 4,
wherein the antenna is configured to assist communication between a first communication device disposed inside the space having a prescribed shape and a second communication device being outside the space and disposed on a position facing the first communication device across the antenna.

14. The housing according to claim 7,
wherein the antenna is configured to assist communication between a first communication device disposed inside the space having a prescribed shape and a second communication device being outside the space and disposed on a position facing the first communication device across the antenna.

15. The housing according to claim 8,
wherein the antenna is configured to assist communication between a first communication device disposed inside the space having a prescribed shape and a second communication device being outside the space and disposed on a position facing the first communication device across the antenna.
